(19) United States
(12) Patent Application Publication
(10) Pub. No.: US 2008/0074978 A1
(43) Pub. Date: Mar. 27, 2008

(54) Generation of Channel Bit Data Files Corresponding to Angular Sections of Subtrack, for Recording Optical Metatrack Discs

(75) Inventors: Marius Iosif Boamfa, Eindhoven (NL); Jacobus Hermanus Maria Neijzen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,540

(22) PCT Filed: Sep. 26, 2005
(86) PCT No.: PCT/IB05/53179

§ 371 Date: Apr. 3, 2007

(30) Foreign Application Priority Data
Oct. 8, 2004 (EP) 04104923.0

(51) Int. Cl. G11B 5/09

(52) U.S. Cl. 369/59.24

(57) ABSTRACT

A method and device are disclosed for writing data marks representing a sequence of channel bit values to an optical disc or a master disc along either one or more concentric or spiral data tracks or along at least one concentric or spiral metatrack consisting of two or more parallel concentric or spiral sub-tracks. The method comprises the steps of—partitioning the sequence of channel bit values into an ordered set of two or more channel bit data files,—providing a periodic rotational motion and a radial motion of the disc and of at least one writing beam spot on the disc relative to each other so as to guide each writing beam spot along at least one data track or sub-track,—periodically providing an angular position signal derived from the rotational motion and indicative of the completion of one full turn of the rotational motion or a predetermined fraction thereof,—switching to a respective channel bit data file next in order with each angular position signal and writing a respective section of the sequence of channel bit values contained therein to the disc. According to the method of the invention, in the partitioning step the length of a respective section of the sequence of channel bit values to be contained by a respective channel bit data file is determined such that the complete respective section of the sequence of channel bit values contained by the channel bit data file is written to the disc between two consecutive angular position signals. The method provides an enhanced precision in the alignment of data marks, which is especially useful for synchronizing two-dimensional data patterns on a disc. Also disclosed are a method and a device for channel bit data file construction from a sequence of channel bit values, and a channel bit data memory.

The invention relates to a device and a method for writing data marks representing a sequence of channel bit values to an optical disc or a master disc. The invention further relates to a device and a method for channel bit data file construction from a sequence of channel bit values, which are to be written to an optical disc or a master disc along at least one data track in a one-dimensional or two-dimensional, concentric or spiral arrangement of data marks. The invention further relates to a channel bit data memory.

Disc storage media for optical readout employing two-dimensional patterns of data marks are being investigated as a promising way to increase the data rate and data density in comparison to known one-dimensional data mark arrangements such as those used in Compact Discs (CD), Digital Versatile Discs (DVD), and in recent Blu-Ray Discs (BD). An example of an optical disc format with data marks arranged in a two-dimensional pattern has been proposed having a broad spiral track consisting of a number of parallel coplanar sub-tracks. Such a broad spiral data pattern will also be referred to as a meta-spiral. The use of this disc format concept is expected to result in a data capacity of the order of 50 Gigabytes for a disc of 12 cm diameter and a data rate of the order of 300 Megabit/second.

A summary of this project was published under http://www.extra.research.philips.com/euproject/twodos/summary.htm and is outlined in the following. The meta-spiral track of an optical disc having this disc format is to be formed by a number of sub-tracks in the form of coplanar parallel subspirals, which are separated by a predetermined subspiral pitch. The data marks arranged along the parallel subspirals are to form a two-dimensional pattern on the disc, such as a honeycomb structure. Data marks in adjacent sub-tracks are to be read out in parallel by means of a number of reading beam spots. The light from the reading beam spots reflected by the two-dimensional data mark pattern on the disc is to be detected by a set of photo-detectors, which generate a set of high-frequency signal wave forms. The set of signal waveforms is to be used as an input to signal processing in order to reproduce the data stored on the disc.

Two-dimensional data patterns must have a precise mutual alignment of data marks in adjacent tracks for successful read out. The alignment of data marks in adjacent tracks or sub-tracks will also be referred to as track-to-track data synchronization. At present, mastering methods and devices cannot fulfill optimal track-to-track data synchronization over a whole disc.

It is therefore an object of the present invention to provide a device and a method for mastering an optical disc, which is suitable for achieving a precise track-to-track alignment of data marks, especially for two-dimensional data mark patterns.

Another aspect of the object of the invention is to provide a device and a method for channel bit data file construction, which is suitable for achieving a precise track-to-track alignment of data marks, especially for two-dimensional data mark patterns.

A further aspect of the object of the invention is to provide a channel bit data memory, which is suitable for achieving a precise track-to-track alignment of data marks, especially for two-dimensional data mark patterns.

According to a first and second aspect of the invention a method and a device for writing data marks to an optical disc are provided. The following description will start with the more instructive method aspects before turning to the device aspects. In the following, even if only the production of a master disc is addressed, it is understood that the methods and devices described herein are equally applicable in the framework of individual production of an optical disc in a consumer electronics disc drive.

The method of the invention for writing data marks representing a sequence of channel bit values to an optical disc or a master disc along either one or more concentric or spiral data tracks or along at least one concentric or spiral metatrack consisting of two or more parallel concentric or spiral sub-tracks, comprises the steps of

partitioning the sequence of channel bit values into an ordered set of two or more channel bit data files,
providing a periodic rotational motion and a radial motion of the disc and of at least one writing beam spot on the disc relative to each other, so as to guide each writing beam spot along at least one data track or sub-track,
periodically providing an angular position signal indicative of the completion of one full turn of the rotational motion or a predetermined fraction thereof,
switching to a respective channel bit data file next in order with each angular position signal and writing a respective section of the sequence of channel bit values contained therein to the disc.

According to the method of the invention, an ordered set of channel bit data files is constructed prior to the actual process of writing the data marks. In order to achieve a precise mutual alignment of data marks belonging to adjacent tracks in a two-dimensional data pattern, care must be taken when constructing the channel bit data files to include a respective appropriate amount of channel bit data into each channel bit data file.

According to the method of the invention the length of the respective section of the sequence of channel bit values to be contained by a respective channel bit data file is determined in the partitioning step such that the complete respective section of the sequence of channel bit values contained by the channel bit data file is written to the disc between two consecutive angular position signals.

The length of the respective section of the sequence of channel bit values to be contained by a channel bit data file thus corresponds to one period of the angular position signal at a respective allocated radial position or, for a spiral, a respective allocated interval of radial positions. In other words, the length of the respective section to be contained by a respective channel bit data file corresponds to a storage capacity of the length of a track section or subtrack section one corresponding to one full turn (or a fraction thereof) of the rotational motion at a predetermined radial position or radial interval on the disc, given a channel bit size or a size of a hexagonal unit cell in the case of an hexagonal honeycomb data pattern.

The allocation of a respective channel bit data file to a radial position or interval is made on the basis of its position in the ordered set of channel bit data files. To illustrate this point, an embodiment will be outlined in the following. According to this embodiment, a channel bit data file at the first position in a given ordered set of channel bit data files is allocated to a first full turn of the disc, during which the writing beam spot is guided along a radially innermost sub-track of a spiral meta-tracks on the disc. The following channel bit data file is written during the second full turn of the disc to a radially second innermost sub-track, writing of which is started with or immediately after the first angular position signal indicating the completion of the first full turn. This procedure is continued until the last channel bit data file has been written to the disc.

The channel bit data files are ordered so as to reproduce the correct sequence of channel bit values or a correct two-dimensional pattern of data marks representing the sequence of channel bit values on the disc. The order of the channel bit data files can be expressed not only by the physical arrangement of the data files in a memory, but alternatively or in addition also by the file name or a data entry in the file or by means of a list or table giving the correct order of the channel bit data files.

An important feature of the method of the invention is the combination of the partitioning step and the step of providing a periodic angular position signal during the writing process. For triggering the switching from one channel bit data files to the next, the method of the invention uses an angular position signal, which is derived from the rotational motion and indicative of the completion of one full turn of the rotational motion or a predetermined fraction thereof. The angular position signal directly indicates the momentaneous phase of rotational motion. This way, the alignment of data marks can be performed with very high precision and reliability over a full disc. In the prior-art concept a missing channel bit or a slight deviation of the mastering speed propagates much stronger in comparison to the concept of the present invention, which provides a fresh start with each new channel bit data file.

Known methods use a clock signal for driving the rotation of the disc motor, which is derived from the data clock signal. This creates a disadvantageous coupling or interlock between the data clock and the rotation control, which is overcome by the method of the invention. Here, the angular position signal is derived directly from the rotational motion of the writing beam spot and the disc relative to each other. For instance, the angular position signal is derived from an angular position control unit connected with a rotation unit. In particular, the angular position signal is in one embodiment, which is presently preferred, derived from a motor generating the rotational motion, such as a spindle motor. The motor provides a signal at each passing of one or more well defined angular positions. For instance, a so called “pulse-per-revolution” (PPR-)signal is provided, indicating the completion of one full turn of rotational motion with respect to an angular reference position.

The periodic angular position signal corresponds to either one full turn of the disc or a fraction thereof, depending on the particular disc format chosen. It is advantageous to provide angular position signals corresponding to a fraction of a full turn of the disc when using a single writing beam to produce a two-dimensional data mark pattern, for example a broad spiral consisting of a number of parallel coplanar subspirals. In this case it has proven to be advantageous to let the writing beam spot jump between sub-tracks several times during one full turn of the disc in order to keep the distance of the jump small, which secures a precise alignment of the sub-tracks written this way.

The rotational motion is in alternative embodiments either a rotational motion of the disc alone about an axis perpendicular to the disc surface and crossing the center of the disc, or a rotational motion of an optical head alone, which is adapted to deflect and/or focus a writing beam spot onto the disc, performed about the same axis.

In the process of writing data marks to the disc a rotational motion and a radial motion of the disc and of at least one writing beam spot on the disc surface relative to each other guide each writing beam spot along at least one data track or sub-track. The method of the invention therefore can be performed with several writing beam spots. This compatibility with a multi-beam mastering concept and a multi-beam writing format is a particular advantage over existing prior-art mastering methods of two-dimensional data patterns. The method can however, be used equally well with a single-writing-beam mastering equipment. Guiding a writing beam along more than one data track or sub-track implies that jumps between the data tracks or sub-tracks are preformed.

In the following, further preferred embodiments of the method of the fourth aspect of the invention will be described.

One embodiment comprises a step of periodically producing a guard band of at least one full turn of the disc without data marks along at least one single track. A guard band helps to align the reading beam spots during the read-out process.

The guard band is preferably produced by reducing the amplitude of the writing beam while controlling its focus with respect to the disc, with the aid of a focus beam derived from the writing beam. A focus beam can be derived from the writing beam using the reflection of the writing beam spot on the disc. The guard band is produced by switching the intensity of the writing beam spot on the disc to a level low enough to not write data marks, but high enough to further allow controlling the focus of the writing beam spot on the disc.

Of course, the intensity threshold for producing a data mark on the disc depends on the particular photo resist material used during mastering, or on a particular phase change medium of a disc written to by a consumer disc driver. The intensity level necessary to allow controlling the focus of the writing beam spot on the disc depends on the particular focus beam detection equipment used. Employing this embodiment allows to produce guard bands without data marks and switch back to writing data marks without having to bring the writing beam spot back into its optimal focus position.

According to another preferred embodiment the rotational motion has a constant angular velocity when writing data marks to the disc, and wherein the angular velocity is adjusted when a guard band is produced, so as to maintain a linear velocity of the writing beam spot on the disc nearly constant with changing radial position. For writing synchronized data marks in a single-beam multi-pass mode it is essential to rotate the disc in a CAV mode. On the other hand, a constant linear velocity (CLV) mode is preferred for mastering because it ensures an optimal and uniform control of the mastering process. The present embodiment allows to combine the advantages of both modes. While writing to data tracks the rotational motion has a constant angular velocity allowing a precise neutral alignment of data marks in a adjacent sub-tracks of a two-dimensional data mark pattern. When a guard band is produced, i. e., no data marks are written, an adjustment of the angular velocity is performed to keep the linear velocity of the writing beam spot nearly constant with changing radial position. The writing mode of the present embodiment will also be referred to as a quasi-constant linear velocity (QCLV) mode.

Preferably, the angular position signal is provided by a disc motor generating a rotational motion of the disc. This implies that the writing beam head is kept fixed with respect to the rotational motion.

As mentioned before, data marks may be arranged in either a one-dimensional or a two-dimensional arrangement on a disc. Both types of data mark arrangements can be performed using a single writing beam.

In a preferred embodiment of a single-beam multi-pass mastering method the radial motion of the writing beam spot and the disc surface relative to each other comprises a motion component in a first radial direction and periodically repeated jumps in a second radial direction opposite to the first radial direction. In this embodiment the radial motion is a superposition of

a) a first radial motion component, by which the radial position of the writing beam spot on the disc as a function of the angular position with respect to the rotational motion is changed steadily with a first slope, and
b) a periodic second radial motion component, one period of which, plotted as a function of said angular position, is divided into

aa) a first interval, in which the radial position of the writing beam spot on the disc changes with a second slope either in the radial direction of the first radial motion component or in the radial direction opposite thereto, and

bb) an adjacent second interval, in which the radial position of the writing beam on the disc spot changes

in a radial direction opposite to that of the superposition of the first and second radial motion components during the first interval,

with a third slope having an amount larger than the amount of the sum of the first and second slopes.

This embodiment provides a radial motion of the writing beam spot following a sawtooth-like pattern. It allows to precisely arrange data marks in a two-dimensional data pattern with a seamless or nearly seamless continuation of each sub-track. This has the advantage that a reading head in the read-out process will not have to perform jumps to follow the track. This single-beam multi-pass mastering method is particularly suited for the production of a two-dimensional pattern of a broad spiral track containing parallel subspirals.

In a further embodiment the data marks are written to the disc with a number of writing beam spots, the number being smaller than or equal to the number of data tracks. After each angular position signal channel bit values of a number of channel bit data files, which is equal to the number of writing beam spots, are written to the data tracks in parallel. In this embodiment, blocks of channel bit data files are processed in parallel by the writing equipment. For instance, when writing a spiral track containing five subspirals with data marks, five writing beams can be used to write the sub-tracks in parallel. Five channel bit data files will be opened in parallel, and each writing beam will write the data marks contained in one channel bit data file to one respective sub-track.

According to a second aspect of the invention a device is provided for writing data marks to an optical disc or a master disc along at least one data track in a one-dimensional or two-dimensional, concentric or spiral arrangement of data marks, comprising

a disc holding unit
a rotation unit adapted to drive a rotational motion of a disc to be held by the disc holding unit and of at least one writing beam spot on the disc surface relative to each other
a translation unit adapted to drive a radial motion of a disc to be held by the disc holding unit and of at least one writing beam spot on the disc surface relative to each other
an angular position control unit connected with the rotation unit and adapted to periodically provide an angular position signal derived from the rotational motion and indicating that each writing beam spot has passed either one full turn or a fraction thereof in the rotational motion,
a writing unit adapted to generate a writing beam having a modulated intensity and to focus a writing beam spot on a disc positioned in the disc holding unit,
a device for channel bit data file construction according to one of the claims 1 to 3 or a channel bit data memory according to claim 6,
a write control unit connected with the writing unit, the angular position control unit and the device for channel bit data file construction or the channel bit data memory, and adapted to control the intensity of the writing beam according the sequence of channel bit values contained in a respective channel bit data file, which is due in order, and to switch to a respective channel bit data file next in order with each angular position signal received from the angular position control unit.

The device for writing data marks according to the second aspect of the invention implements the method of the first aspect of the invention. The angular position control unit of the device provides the periodic angular position signal derived from the rotational motion to a write control unit. The write control unit is further connected to a device for channel bit data file construction or to a channel bit data memory as described hereinabove. The write control unit is adapted to control the intensity of the writing beam according to the sequence of channel bit values contained in a respective channel bit data file which is due in the order of channel bit data files. This way, data marks corresponding to the channel bit data values in a current channel bit data file or written to the disc. Furthermore, the write control unit is adapted to switch to a respective channel bit data file next in order with each angular position signal received from the angular position control unit. The write control unit controls the operation of a writing unit generating a writing beam and controls its focussing, producing a writing beam spot on a disc positioned in a disc-holding unit according to the method of the invention. The device of the second aspect of the invention can be a mastering device for producing a master disc or a consumer electronics disc driver.

In the following, further preferred embodiments of the device of the second aspect of the invention will be described.

In one embodiment the writing unit is adapted to generate a single writing beam. This embodiment preferably has a control unit adapted to generate and provide control signals to drive the operation of the writing unit, of the rotation unit and of the translation unit such that the data marks are written along a meta-track, which is formed by a number of coplanar parallel sub-tracks in the form of sub-spirals separated by a predetermined subspiral pitch. In this embodiment, the control unit is further adapted to control the operation of the translation unit and of the rotation unit in generating a superposition of a rotational first motion and a radial second motion of the disc and of the writing beam spot on the disc relative to each other, wherein the radial second motion comprises a motion component in a first radial direction and periodically repeated jumps in a second radial direction opposite to the first radial direction, and wherein the radial second motion is a superposition of a first radial motion component and a periodic second radial motion component, as described in the context of the corresponding embodiment of the method of the invention. This embodiment implements the above-described sawtooth-like radial motion of a single writing beam spot in a multi-pass mastering or writing method.

In an alternative embodiment the writing unit is adapted to generate two or more writing beams. In order to allow writing of several channel bit data files in parallel, the write control unit is preferably adapted to allocate a respective channel bit data file to a respective writing beam spot and to control the intensity of all writing beam spots in parallel according to the respective channel bit data files.

A further embodiment implements the method of producing a guard band described above. In this embodiment the device for writing data marks to an optical disc or master disc comprises a focus control detector arranged and adapted to detect a reflected intensity fraction of the writing beam spot from a disc to be held by the disc holding unit and to provide a focus signal indicative of the detected intensity of reflected radiation, a writing beam focussing unit with focussing optics and a focussing actuator connected to the focussing optics and adapted to move the focussing optics to change the size of the writing beam spot on the disc, and a focus control unit adapted to drive the focussing actuator in dependence on the focus signal so as to minimize the size of the writing beam spot on the disc, wherein the write control unit is adapted to switch the intensity of the writing beam spot on the disc between a first and second intensity level, the first intensity level being high enough to write a data mark to the disc and the second intensity being low enough not to write a data mark to the disc but high enough to allow the focus detector to detect a reflected fraction of the writing beam spot.

In order to implement the QCLV mode of mastering or writing the write control unit is in a preferred embodiment further connected to the rotation unit and adapted to maintain a respective constant angular velocity of the rotational motion when writing data marks to the disc, and to adjust the angular velocity when no data mark is written to the disc or, respectively, the intensity of the writing beam is switched to the second intensity level, so as to maintain a linear velocity of the writing beam spot on the disc either constant or nearly constant with changing radial position.

According to a third aspect of the invention, a device is provided for channel bit data file construction from a sequence of channel bit values, which are to be written to an optical disc or a master disc along one or more concentric or spiral data tracks or along at least one concentric or spiral metatrack consisting of two or more parallel concentric or spiral sub-track, comprising

an input unit adapted to receive a sequence of channel bit values,
a disc format unit adapted to provide at its output disc format data containing storage capacity values allocated to an ordered set of predefined angular sections of at least one data track or sub-track on the disc, each angular section covering either one full turn of the disc or a fraction thereof at one respective predetermined radial position or, for a spiral, a respective predetermined interval of radial positions,
a partitioning unit connected to the disc format unit and the input unit and adapted to partition a received sequence of channel bit values into an ordered set of channel bit data files corresponding to the set of angular sections defined by the disc format data.

The device for channel bit data file construction of the third aspect of the invention constitutes a key component of the device of the second invention. It can be integrated into mastering equipment for the mass production of optical discs making use of the method of the first aspect of the invention. At the same time, the device for channel bit data file construction will be an indispensable component of disc drives in the field of consumer electronics enabling an individual user to burn optical discs. The device of the third aspect of the invention implements the partitioning step performed in the framework of the method of the first aspect of the invention. It is the partitioning step, which allows to switch from channel bit data file to channel bit data file with each angular position signal, and thus to produce a precise alignment of data marks, as described earlier.

The device for channel bit data file construction comprises a disc format unit containing disc format data for one or more one-dimensional or two-dimensional, concentric or spiral arrangements of data marks along one or more concentric or spiral data tracks or along at least one concentric or spiral metatrack consisting of two or more parallel concentric or spiral sub-track. The disc format data contains storage capacity values for predefined angular sections of one or more data tracks or sub-tracks on the disc. An angular section of a data track or a sub-track is formed by one full turn of the rotational motion or by a predetermined fraction thereof at one respective predetermined radial position or, for a spiral, a respective predetermined interval of radial positions. The disc format unit provides the disc format data in alternative embodiments by either accessing a table locating to each angular section of each track of an optical disc a respective storage capacity value, or by sequentially calculating the respective storage capacity values according to an algorithm implemented by software or hardware.

The disc format data provided by the disc format unit are used by the partitioning unit of the device for channel bit data file construction to partition a received sequence of channel bit values into an ordered set of channel bit data files. As a result, the channel bit data to be written to the disc in different angular sections and different tracks are kept in separate files. The data contained in each file exactly fill an allocated angular section on the disc. The data file structure produced by the device of the first aspect of the invention allows to generate two-dimensional patterns of data marks with a precise mutual alignment of data marks in adjacent tracks or sub-tracks, because the data meant to be synchronized are in accordance with the period of the angular position signal generated in the writing method of the first aspect of the invention.

Synchronized data marks can be written at any radius with no limitation of disc rotation speed or channel bit length without loosing the relative alignment between sub-tracks. In comparison, according the prior-art concept of channel bit data file construction, any change in mastering rotation speed or channel bit time requires a construction of a new channel bit data file. In the prior-art concept a missing channel bit or a slight deviation of the mastering speed propagates much stronger in comparison to the concept of the present invention, which provides a fresh start with each new channel bit data file.

The disc format unit may be adapted to provide disc format data only for one particular disc format, for example a broad spiral consisting of seven coplanar parallel sub-tracks in the form of subspirals with a given subspiral pitch and a given track pitch in another embodiment the disc format unit is adapted to provide disc format data for two or more arrangements of data marks on a master disc, be it a one-dimensional or two-dimensional, concentric or spiral arrangement of data marks. In this embodiment, the disc format unit is further adapted to interpret a control signal received through the input unit and selecting a particular disc format. The disc format unit will only provide disc format data according to the selected disc format.

In the following sections, further advantageous embodiments of the device for a channel bit data file construction of the third aspect of the invention will be described.

In a first preferred embodiment the partitioning unit is adapted to allocate to each channel bit data file a respective section of the sequence of channel bit values, the length of the sequence being chosen according to the storage capacity of the respective angular section.

In a further preferred embodiment the device for data file construction comprises a channel bit data memory connected with the partitioning unit, wherein the partitioning unit is adapted to store the ordered set of channel bit data files in the channel bit data memory.

According to a fourth aspect of the invention a method for channel bit data file construction from a sequence of channel bit values is provided, which are to be written to an optical disc or a master disc along one or more concentric or spiral data tracks or along at least one concentric or spiral metatrack consisting of two or more parallel concentric or spiral sub-track, comprising a step of

partitioning the sequence of channel bit values into an ordered set of two or more channel bit data files,

wherein each channel bit data file contains a respective section of the sequence of channel bit values, the length of the section being chosen in dependence on a storage capacity of a respective allocated angular section of a single data track, each angular section covering either one full turn of the disc or a fraction thereof at one respective predetermined radial position or, for a spiral, a respective predetermined interval of radial positions.

Advantages of the method according to the fourth aspect of the invention correspond to those described above for the corresponding device. The method can be implemented without relying on the particular structure of the device for channel bit data file construction described above.

In a preferred embodiment of the method of the second aspect of the invention, the channel bit data files are constructed such that each file contains a respective integer number of information frames. Each information frame contains a preset number of channel bit values. The respective number of information frames is the maximum number of information frames allowed by the storage capacity of the respective allocated angular section of the data track. The usual number of frames to be written in one disc circumference is of the order of 10³. Thus, if any disc space remains unused due to the requirement of partitioning the channel bit data into frames, it will correspond to less than one frame, which represents less than 0.1% of the disc space.

According to a fifth aspect of the invention, a channel bit data memory is provided comprising a set of channel bit data files, each channel bit data file containing a respective section of a sequence of channel bit values, which are to be written to an optical disc or a master disc along one or more concentric or spiral data tracks or along at least one concentric or spiral metatrack consisting of two or more parallel concentric or spiral sub-track,

wherein the length of the respective section of the sequence of channel bit values depends on a storage capacity of a respective allocated angular section of a single data track covering either one full turn of the disc or a fraction thereof at one respective predetermined radial position or, for a spiral, a respective predetermined interval of radial positions.

The channel bit data memory is specific to the methods and devices described hereinabove. It is a product of the device of the third aspect and of the method of the fourth aspect of the invention. It can be used as a plug-in memory in mastering equipment, which does not contain a device for channel bit data file construction according to the third aspect of the invention. The channel bit date memory may also be an integral part of a particular mastering equipment and be connected to a device for channel bit data file construction via a data network. This way, a remote change of channel bit data files is possible when a new master disc is to be produced.

In the following, further preferred embodiments will be described with reference to the enclosed figures.

FIG. 1 shows an illustration of a method for channel bit data file construction and for mastering a two dimensional pattern on the basis of a prior-art cannel bit data file concept.

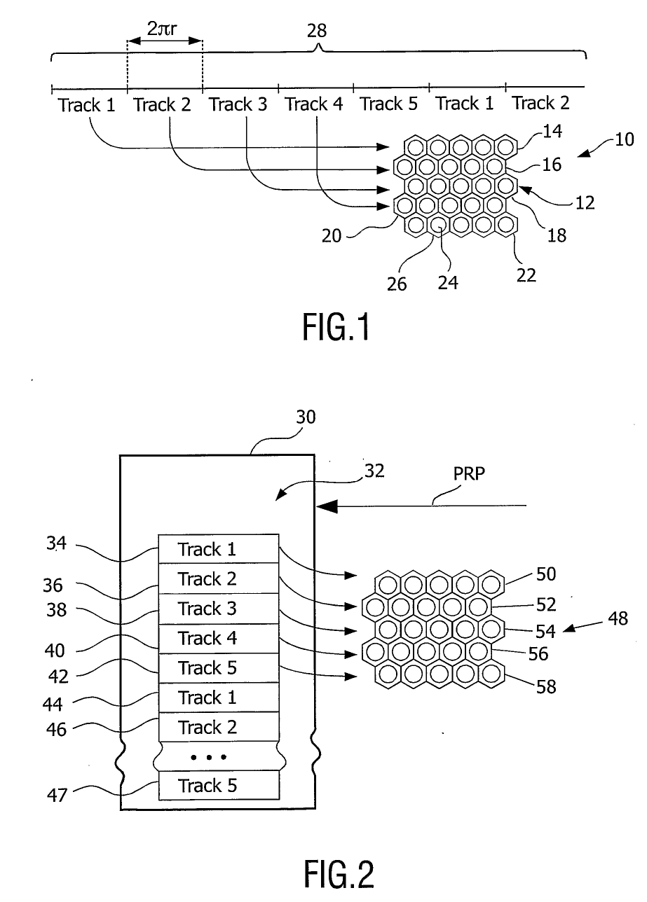

FIG. 2 shows an illustration of an embodiment of a channel bit data memory, also illustrating an embodiment of the mastering method of the invention.

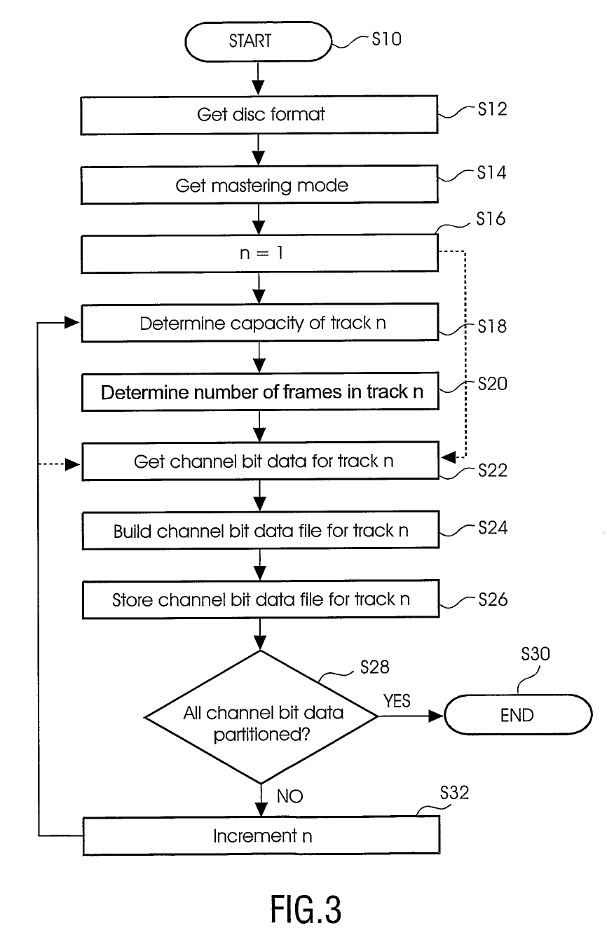

FIG. 3 is a flow diagram of an embodiment of the method for channel bit data file construction of the invention.

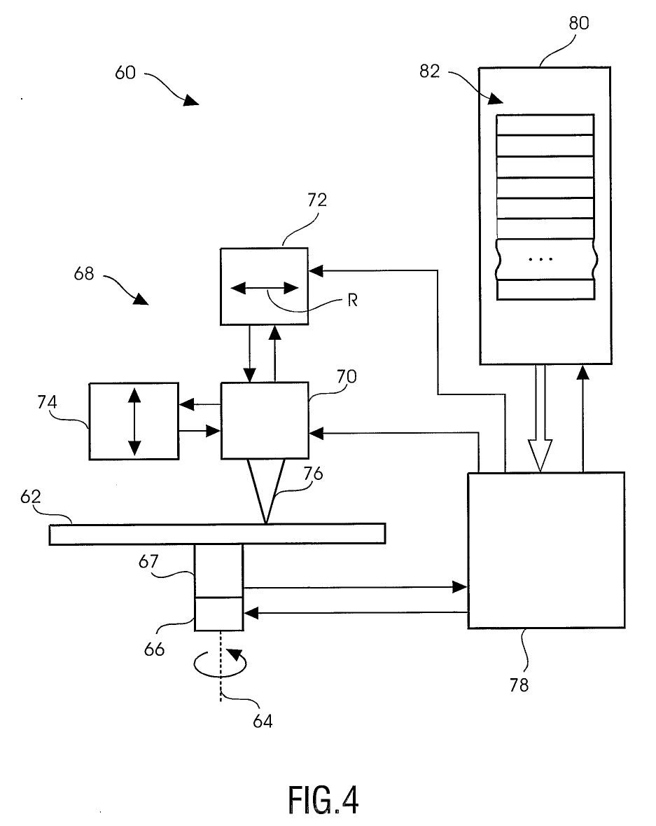

FIG. 4 is a simplified block diagram of a mastering machine according to the method of the invention.

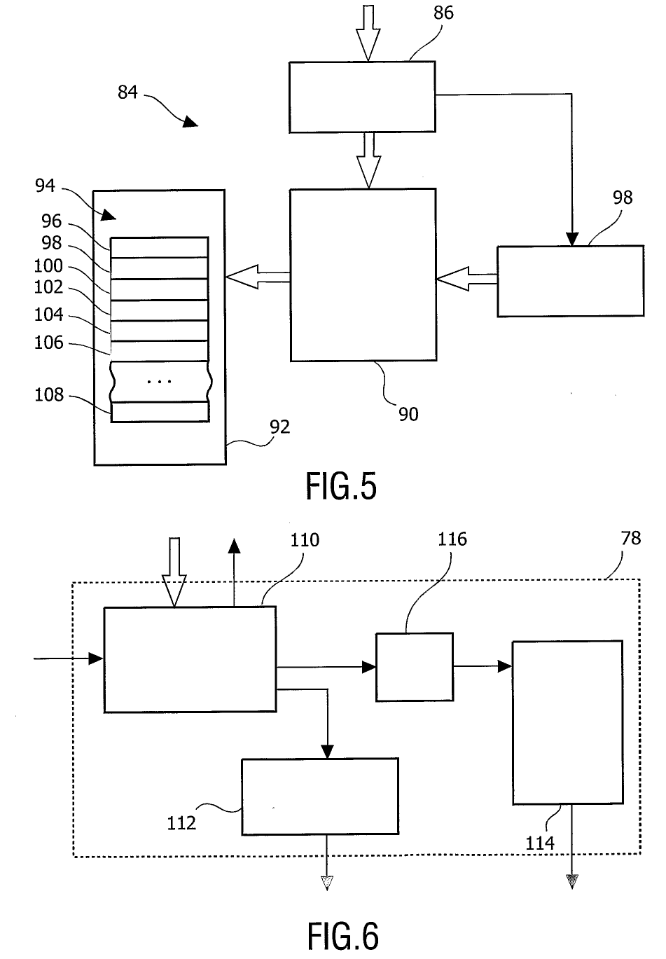

FIG. 5 is a simplified block diagram of an embodiment of a device for channel bit data file construction from a sequence of channel bit values.

FIG. 6 is a simplified block diagram of the write control unit of the mastering device of FIG. 4.

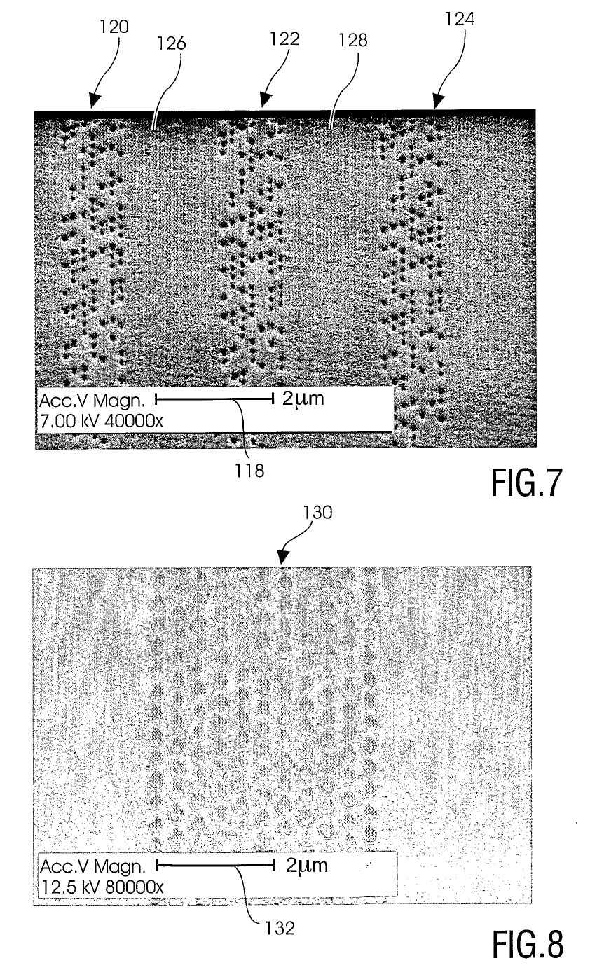

FIG. 7 is a micrograph of three data tracks containing 7 sub-tracks of data marks.

FIG. 8 is micrograph showing synchronised data marks with an enlarged magnification.

Before turning to the description of the invention, an alternative concept based on prior-art mastering concepts will be described below with reference to FIG. 1. The method presented in FIG. 1 is, however, not admitted as prior art. By way of contrast to the alternative concept illustrated in FIG. 1, FIGS. 2 to 8 will illustrate the features and advantages of the present invention more clearly.

Regarding the mastering of such data mark patterns, it is expected that future mastering devices will use multiple writing beam spots, obtained from a laser diode array, still under development at present. Control and alignment of multiple writing beams derived from a single beam, or other methods than a laser diode array, have proven to be difficult to achieve and expensive. Therefore, a single writing beam spot is used at present for mastering two-dimensional data patterns. According to prior art methods the writing beam generates (writes) a sequence of data marks on a master disc track by track in a constant angular velocity (CAV) mode at a given frequency, which strictly depends on the radial position of the writing beam spot and on the channel bit length.

FIG. 1 further illustrates a concept of channel bit data file construction in the process of mastering a two-dimensional pattern 10 of data marks on a disc. The concept is based on known mastering techniques without, however, being admitted public knowledge. The two-dimensional data pattern 10 shown in FIG. 1 represents a section of a broad track 12 (also referred to as a metatrack hereinafter), which is to be formed by five sub-tracks 14 to 22. The sub-tracks 14 to 22 are adjacent to each other with data marks of adjacent tracks arranged in a honeycomb pattern. The data marks are formed on a master disc as pits 24 surrounded by land areas 26. The data pattern forms a hexagonal two-dimensional lattice of data marks.

The channel bit data file 28 for this data pattern, which is to be written in a CAV mode, contains a periodic structure, wherein each period has a sequence of five sections, which are marked “Track 1” to “Track 5” in FIG. 1. Each section contains channel bit values to be written to a respective sub-track on the disc, as indicated by arrows connecting the file sections “Track 1” to “Track 5” with respective tracks of the data pattern. After the section “Track 5”, a next period of track sections in the prior-art channel bit data file 28 starts. Assuming that each section of the channel bit data file contains a channel bit data sequence covering one full turn of the disc, the length of each data sequence in the channel bit data file depends on a chosen value of angular velocity, on a chosen value of a channel bit length, and on the respective radial position of the particular track the data are to be written to.

Special care has to be taken that the sequence of channel bit data values intended to be written at a given track is precisely one disc circumference long. The radial position, where the writing takes place, changes during the disc writing process. The channel bit data file has to be constructed taking this change of radial position into account. Therefore, the length of the sections “Track 1” to “Track 5” within the channel bit data file has to change as the allocated radial writing position changes.

In consequence, the interdependence of the angular velocity of the disc, the radial position of the respective sub-track, and the channel bit length requires a complicated structure of a channel bit data file for mastering a disc with a track-to-track synchronization of data marks. In fact, at present, known mastering methods and devices cannot fulfill optimal mastering conditions over the whole disc using this concept.

FIG. 2, in contrast, shows an illustration of an embodiment of a channel bit data memory of the invention, also illustrating an embodiment of the mastering method of the invention.

The channel bit data memory 30 of FIG. 2 contains an ordered set 32 of channel bit data files 34 to 46. Similar to the situation illustrated in FIG. 1, the channel bit data values contained in the set 32 of channel bit data files are to be written to a broad track 48 comprising five sub-tracks 50 to 58 with data marks arranged in a honeycomb pattern.

In contrast to the prior-art concept shown in FIG. 1, which was described above, there is one channel bit data file allocated to one respective sub-track. For instance channel bit data file 34 is allocated to sub-track 50, channel bit data file 36 is allocated to sub-track 52, and so on. Channel bit data file 54 is allocated to the continuation of sub-track 50 in a consecutive full turn of the broad track 48 (not shown). Similarly, channel bit data file 46 is allocated to a continuation of sub-track 52. The last channel bit data file 47 in order is allocated to the continuation of sub-track 58 in an outermost turn of the broad track 48 on the master disc. The arrangement of channel bit data files in channel bit data memory 30 enables a simplified handling in comparison with the known previous concept shown in FIG. 1. A full optical disc is possible to be written with synchronized data marks. Any radius, angular velocity and data clock combinations are possible, ensuring precise mastering over the full disc extent.

When writing the data contained in channel bit data memory 30 to a master disc, the writing will begin with channel bit data file 34 at a given radial marker. Upon a full disc rotation, the disc motor will provide a synchronisation signal, also referred to as the “pulse-per-revolution” (PPR) signal. Upon receiving the PPR signal the writing process will switch to the next channel bit data file 36 in order to write to sub-track 52. This is symbolized by an arrow “PPR” in FIG. 2. The process continues until the first full turn of all five sub-tracks 50 to 58 is written. In the following, an empty guard band will be produced before the next turn of broad track 48 will be written to the master disc.

The data structure shown in FIG. 2 can be scaled easily for a broad track with a different number of synchronised sub-tracks.

The individual channel bit data files 34 to 47 are made by integer numbers of information frames. Each file contains the maximum number of information frames that can be completely fit in one circumference of the disc at the respective intended radius.

FIG. 3 shows a flow diagram of an embodiment of the method for channel bit data file construction of the invention. The method is started at step S10. In optional steps S12 and S14 the disc format and the mastering mode to be used are obtained. This can be done for instance by evaluating a data input from an operator. However, the disc format and the mastering mode may be fixed so that steps S12 and S14 need not be performed and the method may jump from step S10 to step S16.

At step S16 a track index n is set to the value 1, at steps S18 and S20 the capacity of track n and the number of frames to be contained in track n are determined. Steps S18 and S20 may be omitted where the capacity of the tracks is the same for all values of n. The track capacity is determined in the device for channel bit data file construction by the disc format unit. In a step S22 the channel bit data for track n are obtained and used in step S24 to build a channel bit data file for track n. The channel bit data file just generated is stored in a channel bit data memory in step S26. At step S28 a check is performed whether all channel bit data have been partitioned. If this is the case, the flow of the method branches to step S30, which ends the operation of the algorithm.

If there is still channel bit data to be allocated to new channel bit data files, step S32 is performed to increment the value of the track index by 1. From step S32 the algorithm branches back to step S18 or, optionally, step S22, if the capacity of the next track is known. The optional jumps from step S16 to S22 and from step S32 to step S22 are indicated by dashed arrows connecting the respective method step blocks in FIG. 3.

FIG. 4 shows a simplified block diagram of a mastering machine representing a preferred embodiment of the device of the invention for writing data marks to a master disc.

The mastering device 60 comprises a disc holding unit in the form of a disc support 62, which is pivoted about an axis 64 indicated by a dashed line. The rotational motion of the disc support is driven by a disc motor 66. The angular phase in the rotation about axis 64 is monitored by angular position control unit 67. A writing unit 68 comprises a writing head 70, a radial translation stage 72 and a writing beam focussing unit in the form of a focussing stage 74. A writing beam generated by a writing head 70 is indicated by a cone 76.

The mastering machine 60 further contains a write control unit 78 which is connected to the disc motor 66, angular position control unit 67, the writing head 70, as well as to a channel bit data memory 80. A set 82 of channel bit data files is indicated by a similar graphical representation as in FIG. 2.

In operation, a master disc substrate is positioned on disc support 62. Write control unit 78 provides control signals to disc motor 66 to rotate disc support 62 at a predetermined constant angular velocity. The angular position control unit, which is integrated into disc motor 66 periodically provides a PPR signal, indicating that a full turn has been performed relative to an angular reference position, which typically is the start position of the writing operation.

Write control unit 78 further instructs channel data memory 80 to open the first channel bit data file of set 82 and provide the channel bit data values contained therein at its output. Write control unit 78 uses the channel bit data received from channel data memory 80 to generate intensity control signals and transmits these intensity control signals to writing head 70. Writing head 70 receives the intensity control signals from write control unit 78 and controls the intensity of the writing beam 76 accordingly to generate data marks on the disc. While modulating the writing beam intensity, the writing head is moved in a radial direction indicated by double arrow R. The general direction of the radial motion of writing head 70 is directed away from the rotational axis 64. However, to produce a meta-spiral data pattern consisting of a number of parallel coplanar subspirals with a predetermined subspiral pitch and a predetermined meta-spiral track pitch, the write control unit controls the translation stage to perform a saw-tooth-shaped motion as described earlier with reference to another preferred embodiment of the invention. Writing head 70 and translation stage 72 exchange signals to control and maintain the correct radial position of the beam spot formed by writing beam 76 on the disc.

The distance of writing head 70 from the disc surface is controlled by a focus control unit 74, by driving a focussing actuator (not shown) to adjust the size of the writing beam spot on the disc. The writing head 70 contains focussing optics driven by a focussing actuator, which receives control signals from focus control unit 74.

Write control unit 78 switches the intensity of the writing beam spot on the disc from a higher level suitable for writing a data mark to a lower level, at which no data mark is written, when a guard band is to be produced on the disc. However, the intensity of the writing beam 76 is maintained high enough to allow a focus control detector (not shown) contained in writing head 70 to receive a reflected intensity fraction of the writing beam spot from the disc, allowing focus control unit 74 to keep the writing beam spot in focus.

Write control unit 78 switches from channel bit data file to channel bit data file with each PPR signal received from disc motor 66, until all channel bit data files contained in the set 82 have been written to the disc.

During the production of the guard bands on the disc, write control unit 78 drives disc motor 66 to adjust the angular velocity of the rotational motion of the disc support to accommodate the change of radial position of the writing beam spot on the disc so as to keep the linear velocity of the writing beam spot on the disc nearly constant.

This way, the mastering device 60 is able to produce a two-dimensional data pattern with a precise mutual alignment of data marks in adjacent sub-tracks over a full master disc.

The structure of the mastering machine of FIG. 4 also applies to a consumer disc drive adapted to write to a disc with a phase change medium, or the like. FIG. 5 shows a simplified block diagram of a device for channel bit data file construction. The device 84 has an input unit 86, a disc format unit 88, a partitioning unit 90 and a channel bit data memory 92.

The input unit 86 has a data input connected with an external data source (not shown) and a data selection and forwarding unit (not shown) connecting the input unit to the disc format unit 88 and to the partitioning unit 90.

Partitioning unit 90 has a buffer memory (not shown) providing intermediate storage capacity for received channel data bit values and received disc format data.

In operation, a sequence of channel bit data received from the external data source is forwarded to the partitioning unit 90. Control signals received from external sources indicating the disc format and further necessary mastering parameters, e.g., the initial radial position of the writing beam are also received by input unit 86 and forwarded to disc format unit 88.

Assuming for example that these control signals contain instructions to produce a master disc with a data pattern in the form of a meta-spiral data track with a given track pitch and having a certain number of sub-tracks in the form of parallel subspirals with a given sub-track pitch, disc format unit 88 provides respective storage capacity values of a number of full turns of the sub-tracks, in accordance with the storage capacity required to store the received channel bit data stream on the disc.

From the channel bit data value stream received partitioning unit 90 builds an ordered set of channel bit data files 96 to 108. Each channel bit data file contains an integer number of data frames, each with a predetermined number channel bit data values. The number of data frames corresponds to the storage capacity, neglecting a rest capacity corresponding to less than one frame size. A next channel bit data file in order continues the stream of channel bit data values where the foregoing file stopped. Depending on the particular design of the partitioning unit, the channel bit data files 96 to 108 can be built sequentially or in parallel. The partitioning unit 90 writes all channel bit data files to channel bit data memory 92. For producing a guard band, all channel data bits are set to “1”, corresponding to the formation of pits or holes, not land. At the same time, in a second channel contained by the channel bit data file intensity values are stored for controlling the intensity of the writing beam. For producing a guard band, the intensity channel values are set to a value that generating a low beam intensity, such that no data marks are produced. This embodiment has the advantage that the writing beam still produces enough intensity reflected from the disc to keep the writing beam in focus. This will be further explained in the context of the embodiment of FIG. 6. It is noted that the mastering machine 60 shown in FIG. 4 may contain the channel bit data file construction device 84 instead of channel bit data memory 80.

FIG. 6 shows a simplified block diagram of some functional components of write control unit 78 of a special embodiment of the mastering machine 60 of FIG. 4, implementing the above-mentioned method for producing a guard band while still maintaining the writing beam in focus. A format generator 110 is connected to channel bit data memory 80 and to disc motor 66 providing the PPR signal. In laboratory use, the format generator may also be replaced by an automatic waveform generator (AWG). The format generator 110 generates control signals from the received channel bit data values. The control signals are transmitted to a modulation unit 112 and forwarded to writing head 70, which generates the writing beam 76 forming the writing beam spot on the disc surface (cf. FIG. 4).

The format generator has a second output for delivering intensity values contained in the previously mentioned second channel of the channel bit data file. The intensity values are forwarded to an intensity controller 114 through an amplification and inversion element 116. It is noted that the amplification and inversion element 116 is specific to the set-up condition and might not be needed in another set-up.

When data marks are to be written, the intensity controller 114 receives “high” intensity values form format generator 110 and generates corresponding control signals for the writing head 70. When a guard band is to be produced, the intensity controller receives “low” intensity values from the format generator 110 and generates corresponding control signals for keeping the spot intensity generated by writing head 70 low. The spot intensity is chosen low enough not to produce any data mark, but high enough to derive a focus beam from the writing beam reflection on the disc.

FIGS. 7 and 8 show scanning electron micrographs obtained from a master disc produced with a mastering machine according to combination of the embodiments of FIGS. 4 and 6. The micrograph of FIG. 7 was taken with a magnification of 40000, a magnification bar indicating a length of 2 micrometer. The micrograph reveals three broad vertical structures 120, 122, and 124, each forming broad track of data marks, which appear as dark dots on a grey background. Each track has seven sub-tracks from left to right. Empty areas 126 and 128 between the tracks are guard bands. A close look at the data patterns of the three tracks 120 to 124 shows that they precisely reproduce identical data patterns at different radial positions on the master disc. FIG. 8 shows a micrograph of a single broad track 130 taken with a magnification of 80000. A magnification bar 132 indicates a length of 1 micrometer. The track 130 contains 11 sub-tracks from left to right with data marks mutually arranged in a honeycomb pattern. This micrograph shows that data marks of adjacent sub-tracks are precisely aligned.

It is noted that the invention is not restricted to the production of discs with two-dimensional data patterns arranged in tracks. Such data patterns as produced with the method and device of the invention can also be used for the development of a copy protection system for any optical disc or for enabling an optical drive to burn labels on any optical disc.

1. A device (84) for channel bit data file (34-47, 96-108) construction from a sequence of channel bit values, which are to be written to an optical disc or a master disc along one or more concentric or spiral data tracks or along at least one concentric or spiral metatrack (48, 120-124, 130) consisting of two or more parallel concentric or spiral sub-tracks (50-58), comprising
an input unit (86) adapted to receive a sequence of channel bit values,
a disc format unit (88) adapted to provide at its output disc format data containing storage capacity values allocated to an ordered set of predefined angular sections of at least one data track or sub-track (50-58) on the disc, each angular section covering either one full turn of the disc or a fraction thereof at one respective predetermined radial position or, for a spiral, a respective predetermined interval of radial positions,
a partitioning unit (90) connected to the disc format unit (88) and the input unit (86) and adapted to partition a received sequence of channel bit values into an ordered set (32, 82, 94) of channel bit data files (34-47, 96-108) corresponding to the set of angular sections defined by the disc format data.

2. The device of claim 1, wherein the partitioning unit (90) is adapted to allocate to each channel bit data file (34-47, 96-108) a respective section of the sequence of channel bit values, the length of the sequence being chosen according to the storage capacity of the respective angular section.

3. The device of claim 1, comprising a channel bit data memory (92) connected with the partitioning unit (90), wherein the partitioning unit (90) is adapted to store the ordered set of channel bit data files (34-47, 96-108) in the channel bit data memory.

4. A method for channel bit data file (34-47, 96-108) construction from a sequence of channel bit values, which are to be written to an optical disc or a master disc along one or more concentric or spiral data tracks or along at least one concentric or spiral metatrack (48, 120-124, 130) consisting of two or more parallel concentric or spiral sub-tracks (50-58), comprising a step of
partitioning (S18-S24) the sequence of channel bit values into an ordered set (32, 82, 94) of two or more channel bit data files (34-47, 96-108),
wherein each channel bit data file (34-47, 96-108) contains a respective section of the sequence of channel bit values, the length of the section being chosen (S18) to fit a storage capacity of a respective allocated angular section of at least one data track or sub-track on the disc, each angular section covering either one full turn of the disc or a fraction thereof at one respective predetermined radial position or, for a spiral, a respective predetermined interval of radial positions.

5. The method of claim 4, wherein the channel bit data files (34-47, 96-108) are constructed (S20, S24) to each contain a respective integer number of information frames, which each contain a preset number of channel bit values,
and wherein the respective number of information frames is the maximum number of information frames allowed by the storage capacity of the respective allocated angular section of the data track.

6. A channel bit data memory (30, 80, 92) comprising a set of channel bit data files (34-47, 96-108), each channel bit data file containing a respective section of a sequence of channel bit values, which are to be written to an optical disc or a master disc along along one or more concentric or spiral data tracks or along at least one concentric or spiral metatrack (48, 120-124, 130) consisting of two or more parallel concentric or spiral sub-tracks (50-58),
wherein the length of the respective section of the sequence of channel bit values depends on a storage capacity of a respective allocated angular section of a single data track covering either one full turn of the disc or a fraction thereof at one respective predetermined radial position or a respective predetermined interval of radial positions.

7. A device (60) for writing data marks to an optical disc or a master disc along one or more concentric or spiral data tracks or along at least one concentric or spiral metatrack (48, 120-124, 130) consisting of two or more parallel concentric or spiral sub-tracks (50-58), comprising
a disc holding unit (62),
a rotation unit (66) adapted to drive a rotational motion of a disc to be held by the disc holding unit (62) and of at least one writing beam spot (76) on the disc surface relative to each other,
a translation unit (72) adapted to drive a radial motion (R) of a disc to be held by the disc holding (62) unit and of at least one writing beam spot (76) on the disc surface relative to each other
an angular position control unit (67) connected with the rotation unit and adapted to periodically provide an angular position signal (PPR) derived from the rotational motion and indicating that each writing beam spot has completed either one full turn or a fraction thereof in the rotational motion,
a writing unit (70) adapted to generate a writing beam (76) having a modulated intensity and to focus a writing beam spot on a disc positioned in the disc holding unit (62),
a device (84) for channel bit data file construction according to claim 1,
a write control unit (78) connected with the writing unit (70), the angular position control unit (67) and the device for channel bit data file construction or the channel bit data memory, and adapted to control and modulate the intensity of the writing beam (76) according the sequence of channel bit values contained in a respective channel bit data file (34-47, 96-108), which is due in order, and to switch to a respective channel bit data file (34-47, 96-108) next in order with each angular position signal (PPR) received from the angular position control unit (67).

8. The device of claim 7, wherein the writing unit (70) is adapted to generate a single writing beam (76).

9. The device of claim 7, wherein the writing unit is adapted to generate two or more writing beams.

10. The device of claim 9, wherein the write control unit (78) is further adapted to allocate a respective channel bit data file (34-47, 96-108) to a respective writing beam spot and to control the intensity of all writing beam spots in parallel according to the respective channel bit data files.

11. The device of claim 7, comprising a focus control detector arranged and adapted to detect a reflected intensity fraction of the writing beam spot (76) from a disc to be held by the disc holding unit and to provide a focus signal indicative of the detected intensity of reflected radiation,
a writing beam focussing unit with focussing optics (70) and a focussing actuator (74), connected to the focussing optics and adapted to move the focussing optics to change the size of the writing beam spot on the disc, and a
a focus control unit adapted to drive the focussing actuator in dependence on the focus signal so as to minimize the size of the writing beam spot on the disc,
wherein the write control unit (78) is adapted to switch the intensity of the writing beam spot (76) on the disc between a first and second intensity level, the first intensity level being high enough to write a data mark to the disc and the second intensity being low enough not to write a data mark to the disc but high enough to allow the focus detector to detect a reflected fraction of the writing beam spot.

12. The device of claim 7, wherein the write control unit (78) is further connected to the rotation unit (66) and adapted to maintain a respective constant angular velocity of the rotational motion when writing data marks to the disc, and to adjust the angular velocity when no data mark is written to the disc or, respectively, the intensity of the writing beam is switched to the second intensity level, so as to maintain a linear velocity of the writing beam spot on the disc either constant or nearly constant with changing radial position.

13. A method for writing data marks representing a sequence of channel bit values to an optical disc or a master disc along either one or more concentric or spiral data tracks or along at least one concentric or spiral metatrack (48, 120-124, 130) consisting of two or more parallel concentric or spiral sub-tracks (50-58), comprising the steps of
partitioning (S18-S24) the sequence of channel bit values into an ordered set (32, 82, 94) of two or more channel bit data files (34-47, 96-108),
providing a periodic rotational motion (64) and a radial motion (R) of the disc and of at least one writing beam spot (76) on the disc relative to each other so as to guide each writing beam spot along at least one data track or sub-track,
periodically providing an angular position signal (PPR) derived from the rotational motion (64) and indicative of the completion of one full turn of the rotational motion or a predetermined fraction thereof,
switching to a respective channel bit data file (34-47, 96-108) next in order with each angular position signal (PPR) and writing a respective section of the sequence of channel bit values contained therein to the disc,
wherein in the partitioning step (S18-S24) the length of a respective section of the sequence of channel bit values to be contained by a respective channel bit data file is determined (S18) such that the complete respective section of the sequence of channel bit values contained by the channel bit data file (34-47, 96-108) is written to the disc between two consecutive angular position signals (PPR).

14. The method of claim 13, wherein the periodic angular position signal (PPR) is provided by an angular position control unit (67) connected to a rotation unit (66) generating the rotational motion.

15. The method of claim 13, comprising a step of periodically producing a guard band of at least one full turn of the disc without data marks along at least one data track or sub-track.

16. The method of claim 15, wherein the focus of the writing beam spot is controlled with the aid of a focus beam derived from the writing beam, and wherein the guard band is produced by switching the intensity of the writing beam spot on the disc to a level low enough to not write data marks, but high enough to further allow controlling the focus of the writing beam spot on the disc.

17. The method of claim 15, wherein the rotational motion has a constant angular velocity when writing data marks to the disc, and wherein the angular velocity is adjusted when a guard band is produced, so as to maintain a linear velocity of the writing beam spot on the disc nearly constant with changing radial position.

18. The method of claim 13, wherein the data marks are written to the disc with a single writing beam spot (76).

19. The method of claim 13, wherein the data marks are arranged in a two-dimensional concentric or spiral arrangement along two or more parallel data tracks,
wherein the data marks are written to the disc with a number of writing beam spots, the number being smaller than or equal to the number of data tracks,
and wherein after each angular position signal channel bit values of a number of channel bit data files, which is equal to the number of writing beam spots, are written to the data tracks in parallel.
